(19) United States
(12) Patent Application Publication
(10) Pub. No.: US 2026/0162505 A1
(43) Pub. Date: Jun. 11, 2026

(54) APPARATUS FOR OPENING, CLOSING, AND LOCKING SHUTTER OF AUTOMATED TELLER MACHINE

(71) Applicant: HYOSUNG TNS INC., Seoul (KR)

(72) Inventors: Jong Seong PARK, Seoul (KR); Chang Ho SEO, Seoul (KR)

(21) Appl. No.: 19/326,818

(22) Filed: Sep. 12, 2025

(30) Foreign Application Priority Data
Dec. 9, 2024 (KR) 10-2024-0181178

(51) Int. Cl. G07F 19/00

(52) U.S. Cl. CPC G07F 19/205

(57) ABSTRACT

According to one embodiment, there is provided an apparatus for opening, closing, and locking a shutter of an automated teller machine, including a shutter that opens or closes a deposit/withdrawal unit of an automated teller machine, a motor that provides a driving force to reciprocate the shutter, a holder that reciprocates by receiving the driving force of the motor, a first roller, a second roller, and a third roller that move in conjunction with the holder, a two-section link including a first link whose both ends are coupled to the first and third rollers and a second link whose both ends are coupled to the second and third rollers and which is connected to the first link, a shutter coupling frame connecting the two-section link to the shutter, a first rail along which the first and second rollers reciprocate horizontally, and a second rail including a horizontal section along which the third roller moves horizontally and an inclined section which is connected to the horizontal section and formed to be inclined upward and in which the third roller moves in an inclined direction.

### BACKGROUND

### 1. Field of the Invention

The present invention relates to an apparatus for opening, closing, and locking a shutter of an automated teller machine (ATM), and more specifically, to an apparatus for opening, closing, and locking a shutter of an ATM, which may implement the opening/closing and locking/unlocking operations of a shutter that opens or closes a deposit/withdrawal unit of an ATM with a simple structure.

### 2. Discussion of Related Art

In general, a front portion of an automated teller machine (ATM) is provided with a deposit/withdrawal unit (also referred to as a customer interface unit) that includes a touch pad for allowing a customer to deposit or withdraw banknotes and select financial transactions and has a shutter for opening or closing a banknote deposit/withdrawal slot of the deposit/withdrawal unit.

The shutters of the conventional ATMs are moved by a motor to perform the opening/closing operation and locked by a solenoid after being closed.

In this case, since both the motor and the solenoid are required to implement the operation of opening/closing the shutter and the locking operation of maintaining the closed state, there is a problem that the configuration of an apparatus for opening, closing, and locking the shutter becomes complex, resulting in increased installation costs.

In addition, there is a problem in that the shutter may fail to lock properly due to a malfunction of the solenoid.

The related art related to the apparatus for opening, closing, and locking a shutter of an ATM is disclosed in Korean Registered Patent No. 10-1001695.

### SUMMARY OF THE INVENTION

The present invention is directed to providing an apparatus for opening, closing, and locking a shutter of an automated teller machine, which is capable of implementing opening/closing and locking/unlocking operations of a shutter, which open or close a deposit/withdrawal unit of an automated teller machine with a simple structure.

According to an aspect of the present invention, there is provided an apparatus for opening, closing, and locking a shutter of an automated teller machine, the apparatus comprising: a shutter that opens or closes a deposit/withdrawal unit of an automated teller machine; a motor that provides a driving force to reciprocate the shutter; a holder that reciprocates by receiving the driving force of the motor; a first roller, a second roller, and a third roller that move in conjunction with the holder; a two-section link including a first link whose both ends are coupled to the first and third rollers and a second link whose both ends are coupled to the second and third rollers and which is connected to the first link; a shutter coupling frame that connects the two-section link to the shutter; a first rail along which the first and second rollers reciprocate horizontally; and a second rail including a horizontal section along which the third roller moves horizontally and an inclined section which is connected to the horizontal section and formed to be inclined upward and in which the third roller moves in an inclined direction.

The first and second rollers are provided on both sides of the two-section link, and the third roller is located between the first and second rollers and is provided on a central portion of the two-section link to which the first and second links are connected.

The first and second rails are provided in parallel at locations spaced apart from each other in a lateral direction orthogonal to a direction in which the shutter reciprocates.

When the shutter is in an open state, the third roller is positioned in the horizontal section, and when the shutter is in a closed state, the third roller is positioned in the inclined section, thereby locking the shutter.

The first rail is formed on a first rail frame provided on a lower side portion of the shutter, and the second rail is formed on a second rail frame provided on one side of the first rail frame.

The horizontal section and the inclined section of the second rail are formed in a shape of a groove at one side of the second rail frame, and when the shutter is in a closed state, the third roller is positioned in the inclined section of the second rail frame, lateral movement of the third roller is restricted by an inner surface of the groove of the inclined section, and the shutter is locked.

The central portion of the two-section link to which the third roller is coupled is bent upward at a predetermined angle so that the third roller is positioned higher than the first and second rollers when the shutter is in an open state.

The holder is coupled to the first link to which the first roller is coupled by a first shaft.

The shutter coupling frame is coupled to the second link to which the second roller is coupled by a second shaft.

When the shutter is in an open state, the third roller is positioned in the horizontal section, and the two-section link is unfolded to both sides, and when the shutter is in a closed state, the third roller is positioned in the inclined section, and the two-section link is folded upward.

Further comprising a limit sensor that detects a detection piece and generates a signal to stop driving of the motor when the two-section link is folded upward while the shutter is in a closed state, wherein the detection piece is formed to protrude from one end of the first link to which the first roller is coupled.

Which is provided as a pair of apparatuses for opening, closing, and locking a shutter of an automated teller machine on both sides of the shutter, wherein the pair of the apparatuses are linked by being connected to a rotational shaft that transmits power of one motor.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a perspective view showing a banknote deposit/withdrawal slot of a deposit/withdrawal unit of an automated teller machine to which the present invention is applied, which is opened by a shutter;

FIG. 2 is a perspective view showing an internal structure of an apparatus for opening, closing, and locking a shutter with the shutter of FIG. 1 in an open state;

FIG. 3 is a perspective view showing a main part of the apparatus for opening, closing, and locking a shutter with the shutter in the open state;

FIG. 4 shows a rear view (see FIG. 4A) and a rear perspective view (see FIG. 4B) of a second rail frame constituting the apparatus for opening, closing, and locking a shutter of the present invention;

FIG. 5 is a front view of FIG. 2;

FIG. 6 is a front view of FIG. 3;

FIG. 7 is a rear view of FIG. 5;

FIG. 8 is a perspective view showing a banknote deposit/withdrawal slot of a deposit/withdrawal unit of an automated teller machine to which the present invention is applied, which is closed by a shutter;

FIG. 9 is a perspective view showing a main part of the apparatus for opening, closing, and locking a shutter with the shutter in the closed state;

FIG. 10 is a front view of FIG. 8;

FIG. 11 is a front view of FIG. 9; and

FIG. 12 is a rear view of FIG. 10.

### DETAILED DESCRIPTION OF EXEMPLARY EMBODIMENTS

Hereinafter, configurations and operations of exemplary embodiments of the present invention will be described in detail with reference to the accompanying drawings. Hereinafter, when referring to a front-rear direction, a side where a deposit/withdrawal unit 100 is located is referred to as the front, and an opposite side is referred to as the rear.

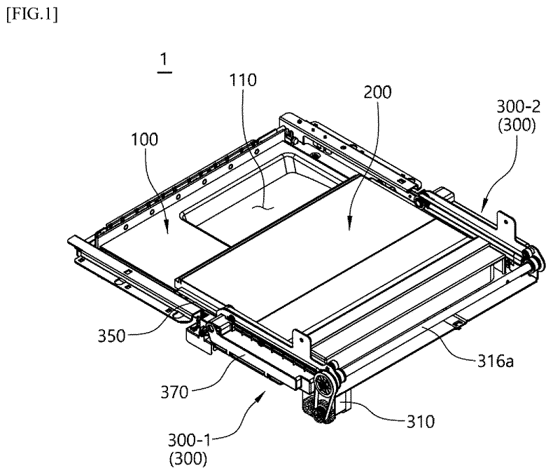

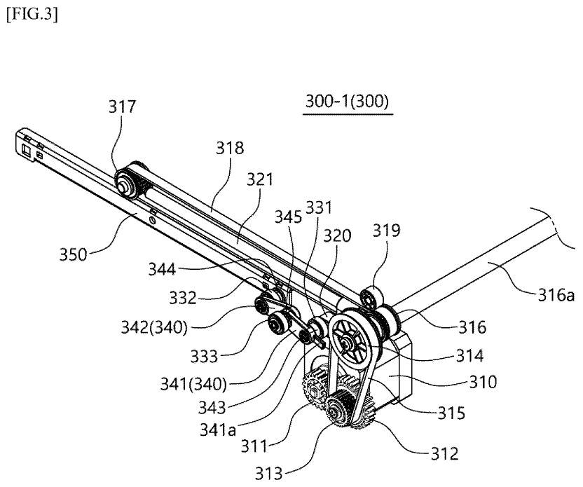

Referring to FIGS. 1 to 3, a front portion 1 of an automated teller machine includes a deposit/withdrawal unit 100, a shutter 200 that reciprocates to open or close the deposit/withdrawal unit 100, and an apparatus 300 (300-1 and 300-2) for opening, closing, and locking a shutter, which reciprocates the shutter 200 and locks the shutter 200 to maintain a closed state.

The deposit/withdrawal unit 100 includes a banknote deposit/withdrawal unit 110 for a customer to deposit or withdraw banknotes.

The shutter 200 may be formed of a liquid crystal display (LCD) and include a touch pad and a security module for selecting a financial transaction desired by the customer.

The apparatus 300 (300-1 and 300-2) for opening, closing, and locking a shutter is provided as a pair on both sides of the shutter 200, and the pair of apparatuses 300 (300-1 and 300-2) for opening, closing, and locking a shutter are connected and linked to a rotational shaft 316a that transmits power from a single motor 310. When the motor 310 is driven in one direction, the pair of apparatuses 300 (300-1 and 300-2) for opening, closing, and locking a shutter move the shutter 200 in an opening direction, and when the motor 310 is driven in a direction opposite to the one direction, the pair of apparatuses 300 (300-1 and 300-2) for opening, closing, and locking a shutter move the shutter 200 in a closing direction.

Hereinafter, the configuration and operation of the present invention will be described based on the apparatus 300 (300-1) for opening, closing, and locking a shutter provided at one side of the apparatus 300 (300-1 and 300-2) for opening, closing, and locking a shutter.

Referring to FIGS. 1 to 8, the apparatus 300 for opening, closing, and locking a shutter of an automated teller machine of the present invention includes the motor 310 for providing a driving force so that the shutter 200 reciprocates, a holder 320 that receives the driving force of the motor 310 and reciprocates, a first roller 331, a second roller 332, and a third roller 333 that move in conjunction with the holder 320, a two-section link 340 in which the first roller 331, the second roller 332, and the third roller 333 are coupled and to which the first link 341 and the second link 342 are connected, a shutter coupling frame 350 that connects the two-section link 340 to the shutter 200, a first rail 361 in which the first roller 331 and the second roller 332 reciprocate horizontally, and a second rail 371 including a horizontal section 371a along which the third roller 333 moves horizontally and an inclined section 371b which is connected to the horizontal section 371a, formed to be inclined upward, and along which the third roller 333 moves in an inclined direction.

A motor gear 311 is coupled to the rotational shaft of the motor 310, a connecting gear 312 is gear-coupled to one side of the motor gear 311, and a first pulley 313 is coupled to the same shaft as the connecting gear 312. A second pulley 314 is provided above the first pulley 313, and a first belt 315 that transmits power while traveling along the first pulley 313 and the second pulley 314 is provided. A rotational shaft 316a is coupled to the second pulley 314, and a third pulley 316 is provided on the rotational shaft 316a at one side of the second pulley 314. A fourth pulley 317 is provided in front of the third pulley 316, and a second belt 318 that transmits power while traveling along the third pulley 316 and the fourth pulley 317 is provided. The tension of the second belt 318 may be adjusted by a tension roller 319.

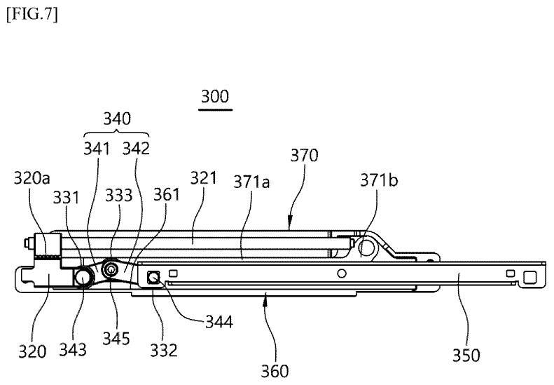

A belt coupling portion 320a (see FIG. 7) of the holder 320 is coupled to the second belt 318, and a holder guide shaft 321 having a length in the front-rear direction passes through the holder 320. Accordingly, when the second belt 318 travels, the holder 320 may move forward and rearward along the holder guide shaft 321.

The first roller 331 and the third roller 333 are coupled to both ends of the first link 341 of the two-section link 340, and the second roller 332 and the third roller 333 are coupled to both ends of the second link 342 of the two-section link 340. The third roller 333 is coupled to a central portion to which the first link 341 and the second link 342 are connected.

The first roller 331 and the second roller 332 are coupled to both sides of the two-section link 340, and the third roller 333 is located between the first roller 331 and the second roller 332 and is coupled to the central portion of the two-section link 340 to which the first link 341 and the second link 342 are connected.

The first roller 331 is coupled to a rear end of the first link 341 by a first shaft 343, and the holder 320 is coupled to the first shaft 343.

The second roller 332 is coupled to a front end of the second link 342 by the second shaft 344, and a shutter coupling frame 350 is coupled to the second shaft 344.

The third roller 333 is coupled to the central portion of the two-section link 340 to which the rear end of the first link 341 and the front end of the second link 342 are connected by the third shaft 345.

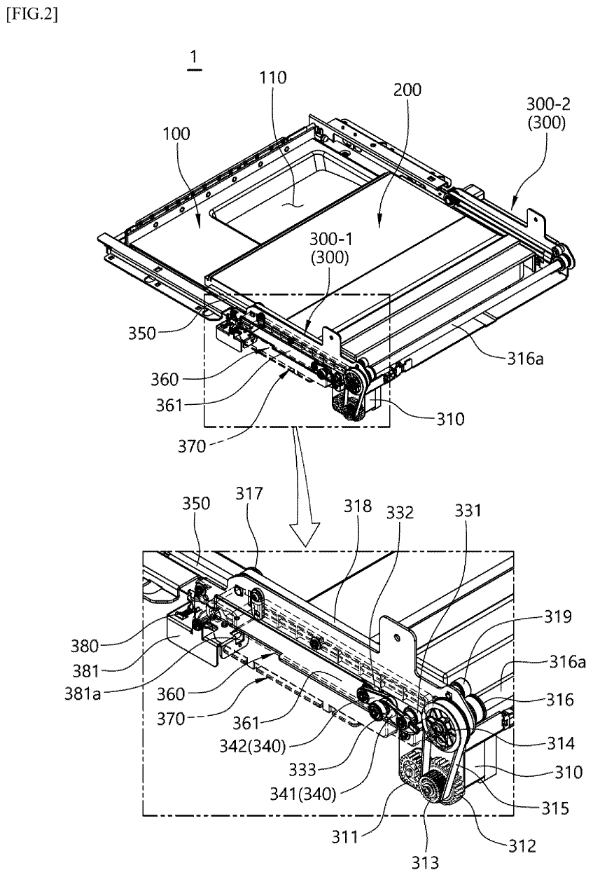

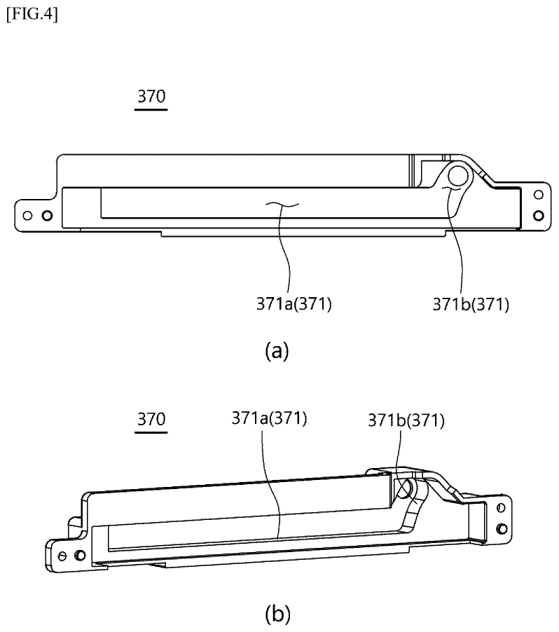

Referring to FIGS. 2 and 4, the first rail 361 and the second rail 371 are provided in parallel at locations spaced apart from each other in a lateral direction orthogonal to a direction in which the shutter 200 reciprocates. The first rail 361 is formed on a first rail frame 360 provided on a lower side portion of the shutter 200, and the second rail 371 is formed on a second rail frame 370 provided at one side of the first rail frame 360. The second rail 371 includes the horizontal section 371a and the inclined section 371b that are formed in the second rail frame 370.

The horizontal section 371a and the inclined section 371b of the second rail 371 are formed in the shape of a groove at one side surface of the second rail frame 370, and when the shutter 200 is in a closed state, the third roller 333 may be positioned in the inclined section 371b of the second rail frame 370, and its lateral movement may be restricted by an inner surface of the groove of the inclined section 371b, thereby locking the shutter 200.

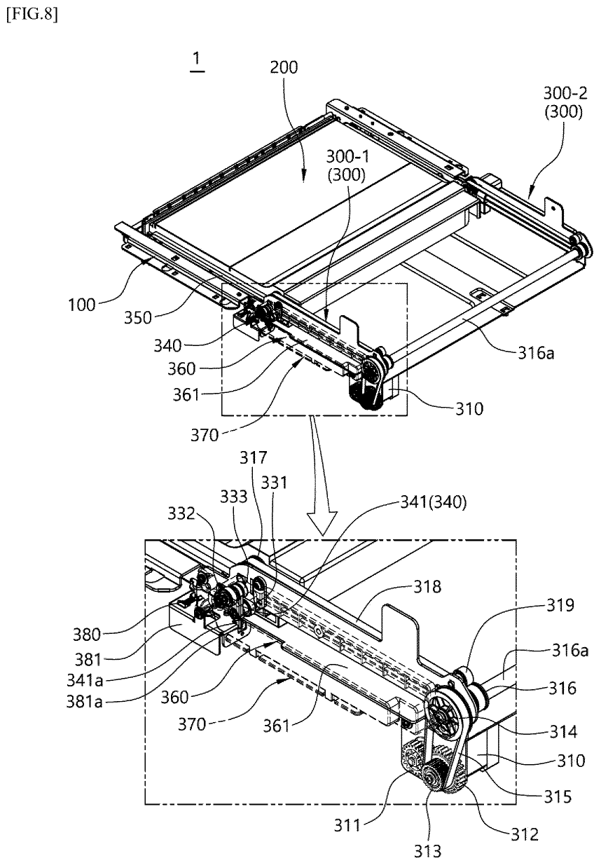

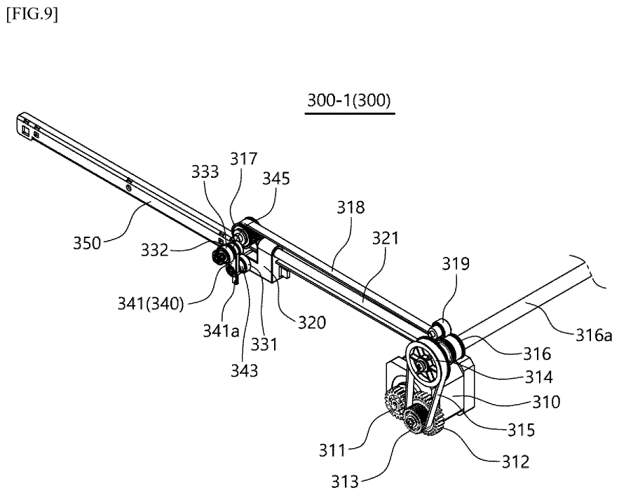

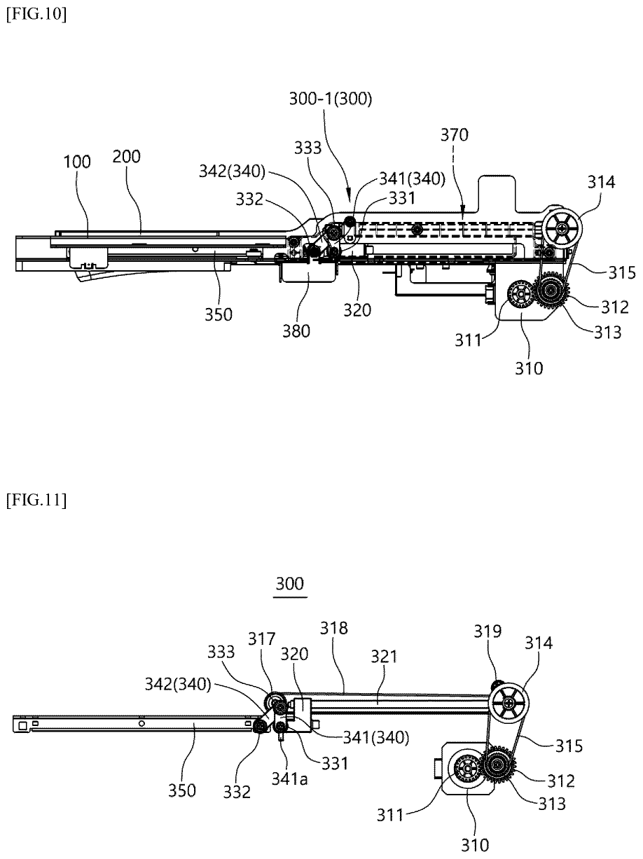

FIGS. 1 to 7 show a state in which the deposit/withdrawal unit 100 is opened due to the forward movement of the shutter 200, and FIGS. 8 to 12 show a state in which, due to the forward movement of the shutter 200, the deposit/withdrawal unit 100 is closed and the shutter 200 is locked. Here, the locked state of the shutter 200 means that the shutter 200 is maintained in the closed state even when an external force is applied to the shutter 200 rearward in the closed state of the shutter 200.

When the shutter 200 is in an open state, the third roller 333 is positioned in the horizontal section 371a, and when the shutter 200 is in a closed state, the third roller 333 is positioned in the inclined section 371b, and thus the shutter 200 may be locked.

When the third roller 333 is positioned in the inclined section 371b with the shutter 200 in the closed state, even when the shutter 200 is forced rearward by an external force, the third roller 333 may be laterally blocked by the inclined section 371b and suppressed from moving rearward, thereby maintaining the closed and locked state of the shutter 200 without opening the shutter 200. The third roller 333 may be moved from the inclined section 371b to the horizontal section 371a by only the driving of the motor 310, thereby unlocking the shutter 200.

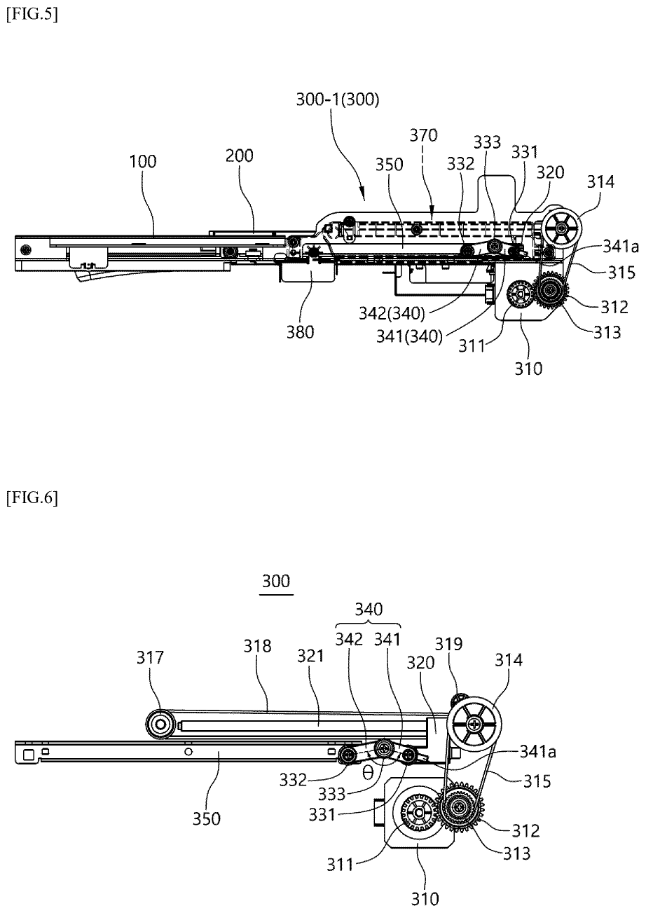

Meanwhile, referring to FIG. 6, the central portion of the two-section link 340 to which the third roller 333 is coupled is bent upward at a predetermined angle θ so that the third roller 333 is positioned higher than the first roller 331 and the second roller 332 when the shutter 200 is in an open state. Accordingly, during the locking operation of the shutter 200, when the third roller 333 enters the inclined section 371b through the horizontal section 371a of the second rail 371, the third roller 333 can smoothly move toward the inclined section 371b formed to be inclined upward by the upward bent structure of the central portion of the two-section link 340, thereby smoothly performing the locking operation of the shutter 200.

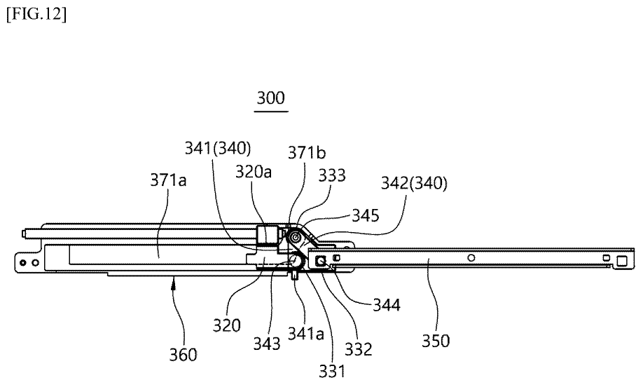

As shown in FIGS. 6 and 7, when the shutter 200 is in the open state, the third roller 333 is positioned in the horizontal section 371a and the two-section link 340 is unfolded to both sides, and as shown in FIGS. 11 and 12, when the shutter 200 is in a closed state, the third roller 333 is positioned in the inclined section 371b and the two-section link 340 is folded upward.

Meanwhile, a detection target 341a protruding from one end of the first link 341 to which the first roller 331 is coupled, and a limit sensor 380 that detects the detection target 341a to generate a signal to stop the driving of the motor 310 when the two-section link 340 is folded upward with the shutter 200 in the closed state may be further included. An opening 381a through which the detection target 341a passes is formed in one side of the bracket 381 on which the limit sensor 380 is mounted, and when the detection target 341a passes through the opening 381a and rotates inward from the bracket 381, the limit sensor 380 detects this and generates the signal to stop the operation of the motor 310.

Since a position at which the detection target 341a is detected by the limit sensor 380 corresponds to a state in which the two-section link 240 is folded upward and the shutter 200 is both closed and locked, the operation of the motor 310 is stopped at this time to prevent an overload from the motor 310.

As described above, the apparatus 300 (300-1 and 300-2) for opening, closing, and locking a shutter of an automated teller machine according to the present invention may implement the opening/closing and locking operations of the shutter 200 by a simple structure including one motor 310, the two-section link 340, the first to third rollers 331, 332, and 333 coupled to the two-section link 340, and the first and second rails 361 and 371.

According to an apparatus for opening, closing, and locking a shutter of an automated teller machine according to the present invention, it is possible to implement opening, closing, and locking operations of a shutter, which open or close a deposit/withdrawal unit of an automated teller machine with a simple structure using a driving force of a single motor and a two-section link.

In addition, the opening/closing and locking operations of the shutter can be smoothly performed by providing two rails with a phase difference in a lateral direction and forming first and second rollers moving along a first rail and a third roller moving along a second rail.

In addition, when the shutter is locked, since the third roller is positioned on an inclined section of the second rail, even when an external force is applied to the shutter due to an external intrusion, the movement of the third roller can be restrained by the inclined section of the second rail, thereby maintaining the locked state of the shutter without a separate locking driving unit, such as the conventional solenoid.

In addition, by forming a central portion of the two-section link to which the third roller is coupled to be bent upward at a predetermined angle so that the third roller is positioned higher than the first and second rollers when the shutter is in an open state, the third roller can smoothly move upward along the inclined section after passing through a horizontal section of the second rail during the locking operation of the shutter, thereby smoothly performing the locking operation of the shutter.

Although exemplary embodiments of the present invention have been described above in detail, the present invention is not limited to the above embodiments and may be modified in any form within the scope of the claims, the detailed description of the invention, and the accompanying drawings, and the modifications also pertain to the present invention.

What is claimed is:

1. An apparatus for opening, closing, and locking a shutter of an automated teller machine, the apparatus comprising:
a shutter that opens or closes a deposit/withdrawal unit of an automated teller machine;
a motor that provides a driving force to reciprocate the shutter;
a holder that reciprocates by receiving the driving force of the motor;
a first roller, a second roller, and a third roller that move in conjunction with the holder;
a two-section link including a first link whose both ends are coupled to the first and third rollers and a second link whose both ends are coupled to the second and third rollers and which is connected to the first link;
a shutter coupling frame that connects the two-section link to the shutter;
a first rail along which the first and second rollers reciprocate horizontally; and
a second rail including a horizontal section along which the third roller moves horizontally and an inclined section which is connected to the horizontal section and formed to be inclined upward and in which the third roller moves in an inclined direction.

2. The apparatus of claim 1, wherein the first and second rollers are provided on both sides of the two-section link, and
the third roller is located between the first and second rollers and is provided on a central portion of the two-section link to which the first and second links are connected.

3. The apparatus of claim 1, wherein the first and second rails are provided in parallel at locations spaced apart from each other in a lateral direction orthogonal to a direction in which the shutter reciprocates.

4. The apparatus of claim 1, wherein, when the shutter is in an open state, the third roller is positioned in the horizontal section, and
when the shutter is in a closed state, the third roller is positioned in the inclined section, thereby locking the shutter.

5. The apparatus of claim 1, wherein the first rail is formed on a first rail frame provided on a lower side portion of the shutter, and
the second rail is formed on a second rail frame provided on one side of the first rail frame.

6. The apparatus of claim 5, wherein the horizontal section and the inclined section of the second rail are formed in a shape of a groove at one side of the second rail frame, and
when the shutter is in a closed state, the third roller is positioned in the inclined section of the second rail frame, lateral movement of the third roller is restricted by an inner surface of the groove of the inclined section, and the shutter is locked.

7. The apparatus of claim 2, wherein the central portion of the two-section link to which the third roller is coupled is bent upward at a predetermined angle so that the third roller is positioned higher than the first and second rollers when the shutter is in an open state.

8. The apparatus of claim 2, wherein the holder is coupled to the first link to which the first roller is coupled by a first shaft.

9. The apparatus of claim 2, wherein the shutter coupling frame is coupled to the second link to which the second roller is coupled by a second shaft.

10. The apparatus of claim 2, wherein, when the shutter is in an open state, the third roller is positioned in the horizontal section, and the two-section link is unfolded to both sides, and
when the shutter is in a closed state, the third roller is positioned in the inclined section, and the two-section link is folded upward.

11. The apparatus of claim 10, further comprising a limit sensor that detects a detection piece and generates a signal to stop driving of the motor when the two-section link is folded upward while the shutter is in a closed state,
wherein the detection piece is formed to protrude from one end of the first link to which the first roller is coupled.

12. The apparatus of claim 1, which is provided as a pair of apparatuses for opening, closing, and locking a shutter of an automated teller machine on both sides of the shutter,
wherein the pair of the apparatuses are linked by being connected to a rotational shaft that transmits power of one motor.
